(19) United States
(12) Patent Application Publication
(10) Pub. No.: US 2006/0155738 A1
(43) Pub. Date: Jul. 13, 2006

(54) Monitoring method and system

(76) Inventors: Adrian Baldwin, Bristol (GB); David Plaquin, Bristol (GB); Nicholas Murison, Bristol (GB); Yolanta Beresnevichiene, Bristol (GB)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/302,700

(22) Filed: Dec. 14, 2005

(30) Foreign Application Priority Data
Dec. 16, 2004 (GB) 0427628.3
Sep. 15, 2005 (GB) 0518780.2
Oct. 14, 2005 (GB) 0520865.7

(51) Int. Cl. G06F 17/00

(52) U.S. Cl. 707/101

(57) ABSTRACT

A monitoring method and system for monitoring compliance of a policy in an IT infrastructure (150) are described. A modeling component (110) and an analysis system (110) are used. The modeling component (110) is arranged to model the policy and configure the analysis system in dependence on the model and the analysis system (100) is arranged to monitor aspects of the IT infrastructure (150) in dependence on the model.

### FIELD OF THE INVENTION

The present invention relates to a system and method that is particularly applicable for monitoring and analyzing operation and compliance of information technology systems and is particularly applicable for use in providing high level monitoring and compliance overviews of complex systems.

### BACKGROUND OF THE INVENTION

Recent events have changed corporate governance. Increasingly, executives are accountable for the way their companies are run and therefore for the underlying critical IT systems. Such IT functions are increasingly outsourced yet executives remain accountable.

Outsourcing may help in meeting budgetary constraints but you cannot outsource accountability. Whether IT systems are internal, outsourced or some mixture of the two, executives must know and be able to demonstrate that their systems are well run, compliant with corporate policies and various pieces of legislation. In the past, this has been achieved by relying on staff to do the right thing along with regular 6 monthly or yearly audits. The climate created by Sarbanes Oxley and similar regulations and legislation makes this insufficient and a more strategic approach to assurance and IT risk management requires regular high level management reviews to ensure ongoing assurance.

This increasing amount of regulation makes it important that those in charge of an enterprise can monitor and understand that IT systems are being correctly managed and run. This problem is becoming particularly pertinent due to new corporate governance laws and regulations where senior management is being held personally liable for non-compliance (e.g. Sarbanes Oxley).

Infrastructure control and transparency are requirements of corporate governance, and indeed good management practice, and must be addressed.

Reliable and clear reporting of the current state of one's infrastructure is therefore becoming a necessity.

Where an IT system is under the full control of a corporate user, it is a complex but tractable matter for the corporate user to assure itself that the IT system is being correctly run in accordance with its corporate requirements and policies, as all elements of the IT system are under its control. Where not all elements of the IT system are under the corporate user's control, this problem becomes much harder. This is because not all information is available to the corporate user, so enabling the corporate user to have a sufficient level of trust in the account it receives of the operation of the IT system is much more difficult. This account should not only be trustworthy, it should also be comprehensible.

Unfortunately, IT infrastructures are renowned for their poor transparency. Even those tasked with their day to day maintenance can find it hard to maintain a detailed overview of the entire environment. As dynamic infrastructures, such as utility computing become commonplace, these problems will only be exacerbated.

IT infrastructures are often monitored via entries in audit logs generated by the infrastructure's respective computer systems and applications. Audit log entries contain descriptions of noteworthy events, warnings, errors or crashes in relation to system programs, system resource exhaustion, and security events such as successful or failed login attempts, password changes etc. Many of these events are critical for post-mortem analysis after a crash or security breach, although for compliance monitoring audit log entries are often too complex, focusing on a specific system aspect or software application. In addition, there is no guarantee that audit log entries will exits or be generated to address specific policy compliance issues.

Current compliance monitoring solutions will often revolve around human auditors occasionally sampling a paper trail (even a digital one) and checking for compliance for the few cases they have time to examine.

Auditors might also use system forensics to get a snapshot of the system behaviour during certain period. These solutions are applied after the fact, e.g. after incident or attack and as such do not work in providing real-time reports.

IT management systems may also be used. Such systems typically have a limited set of agents that sit on remote computer systems and monitor for certain events —when they occur they are sent of a central management point. Such systems are typically extensions of audit logging systems to enable audit events to be reported to a central management point. As such, more audit log entries may be produced and provided to the central management point but this does not in itself increase the transparency of systems and, as discussed above, audit log entries do not easily lend themselves to compliance monitoring.

There are also a number of application specific solutions that check if the specified policies such as security or access control are met in the IT systems. These types of solutions are usually target specific sets of policies, such as privacy compliance, and are applied to specific applications such as databases or network devices. As such they don't take into account overall view from different layers of the system. The reporting is also minimal, mostly it is a binary status report on whether the policy compliance has been met or not.

Utility computing infrastructures are a relatively recent evolution in computing but are becoming increasingly popular. Utility computing infrastructures aim to be flexible and provide adaptable fabrics that can be rapidly reconfigured to meet changing customer requirements. One example is a collection of standard computer servers interconnected using network switches with utility storage provided via some form of SAN technology. Separation of customers within a utility computing system is usually provided by a combination of router and firewall configurations, along with any additional security capability the network switches may offer, such as VLANs.

Utility computing has the potential to revolutionize the way businesses fulfill their IT infrastructure and service needs. It holds the promise of delivering IT resources to a business as and when needed and with a degree of flexibility and cost efficiency simply not possible with conventional in-house provision of computing infrastructure and services. However, businesses need to be persuaded that they can trust their precious data sets and secure transactions to a utility provider. In order to be financially viable, a utility provider will often simultaneously host multiple businesses using a common physical infrastructure such as a data centre.

Utility computing provides a further challenge for companies in that they need to know that the shared infrastructure is being properly run. Problems here are that multiple compliance reports must be generated for various customers and that some of this may be based on shared infrastructure data. Additionally the utility may not wish to expose the complete workings of a procedure such as a staff vetting process (involving personal data) but to give a statement saying that the processes were working.

In utility computing, resources are leased from a remote provider. An example of IT infrastructures using a utility computing infrastructure is shown in FIG. 1. The remote provider may share resources between multiple customers 10, 20. For example, the first customer 10 may have outsourced operation of a database system 30 whilst the second customer may be leasing processor time for running a complex modeling system 40. However, even though both customers may be provided significantly different services, it is possible that a single system 50 maintained by the remote provider may be running processes for both customers concurrently.

One of the major issues with distributed systems such as those using utility computing, in the context of compliance monitoring is data access. It is likely that a utility computing service provider will not wish for all data to be accessible to its customers. Indeed, at least a proportion of the data may be relevant only to a single customer and confidentiality requirements would prevent this being disclosed to other parties without consent. The more dynamic the infrastructure of a distributed system, the more complex it becomes to determine who has rights to what data. In addition, data is not always proportional to the size of the respective infrastructure and as the size of the infrastructure grows, so too does the audit log data but at closer to an exponential rate.

No existing technology is known that works in an adaptive environment. In distributed infrastructures such as in utility computing systems, the infrastructure is constantly flexing and changing, making use of virtualization and on-demand deployment technology to best meet the customer's computing needs. Because such an infrastructure is more optimized, one can expect much larger data throughput in most areas of the network, with a high number of concurrent connections. A centralized audit system could easily buckle under the masses of events generated in such an environment, due to its bottleneck audit database.

Further complications arise from the desired attribute of virtualized data centers to be shared between multiple customers; each customer runs their own virtual infrastructure alongside other customers on the same physical hardware. Having one audit system per customer would work, but essential information regarding the flexing of the infrastructures would often fall outside the customer-specific audit system.

Providing multiple secure customer views of policy compliance in a dynamic, high volume and high concurrency adaptive infrastructure is a challenge which needs to be met to provide sufficient information to allow corporate governance and other similar requirements to be satisfied. The alternative would be to have auditors visit each and every site (which in the case of utility computing may not be permitted or practical) and do the current random sampling of paper trails. Not only is this insufficient for corporate governance requirements, it is also very poor at identifying policy compliance violations in systems.

### STATEMENT OF INVENTION

According to an aspect of the invention, there is provided a monitoring system for monitoring compliance of a policy in an IT infrastructure comprising a modeling component and an analysis system:

the modeling component being arranged to model the policy and configure the analysis system in dependence on the model;

the analysis system being arranged to monitor aspects of the IT infrastructure in dependence on the model.

Preferably, the analysis system includes an agent framework arranged to be deployed to the IT infrastructure for monitoring aspects of the IT infrastructure in dependence on the model, the agent framework including a number of linked agents.

The agent framework may include:

one or more low-level agents arranged to monitor events occurring within the IT infrastructure;

zero or more mid-level agents linked to one or more low-level agents for receiving data from said low-level agents and being responsive to analyze received data; and,

one or more top-level agents linked to one or more low-level or mid-level agents for receiving data from said low-level or mid-level agents.

Preferably, each agent has one or more inputs and includes logic for generating at least one output in dependence on the one or more inputs, each input being from another agent or from an observable of the IT infrastructure.

The analysis system may be arranged to generate a report and populate the report in dependence on data from the agents. Preferably, the report has a hierarchical structure, placement within the report of data from an agent being dependent on the corresponding position of the respective agent within the agent framework. The analysis system may be arranged to generate different views of the report for different user types.

The IT infrastructure may include a database system, one or more of the linked agents being arranged to monitor events or activity occurring within the database system.

According to another aspect of the present invention, there is provided a method of monitoring compliance of a policy in an IT infrastructure comprising:

modeling the policy;

configuring an analysis system in dependence on the model, and,

monitoring aspects of the IT infrastructure by the analysis system in dependence on the model.

The step of configuring the analysis system preferably includes:

generating an agent framework for monitoring aspects of the IT infrastructure in dependence on the model, the agent framework including a number of linked agents; and,

deploying the agent framework to the IT infrastructure.

The step of generating an agent framework may include:

generating one or more low-level agents arranged to monitor events occurring within the IT infrastructure;

generating zero or more mid-level agents linked to one or more low-level agents for receiving data from said low-level agents and being responsive to analyze received data; and,

generating one or more top-level agents linked to one or more low-level or mid-level agents for receiving data from said low-level or mid-level agents.

Each agent may have one or more inputs and includes logic for generating at least one output in dependence on the one or more inputs, each input being from another agent or from an observable of the IT infrastructure.

The method may further comprise:

generating a report; and,

populating the report in dependence on data from the agents. Preferably, the report has a hierarchical structure and placement within the report of data from an agent is dependent on the corresponding position of the respective agent within the agent framework.

The method may further comprise:

generating different views of the report for different user types.

According to another aspect of the present invention, there is provided a computer readable medium having computer readable code means embodied therein for monitoring compliance of a policy in an IT infrastructure and comprising:

computer readable code means for modeling the policy;

computer readable code means for configuring an analysis system in dependence on the model, and,

computer readable code means for monitoring aspects of the IT infrastructure by the analysis system in dependence on the model.

The computer readable code means for configuring the analysis system preferably includes:

compute readable code means for generating an agent framework for monitoring aspects of the IT infrastructure in dependence on the model, the agent framework including a number of linked agents; and,

computer readable code means for deploying the agent framework to the IT infrastructure.

The computer readable code means for generating an agent framework may include:

computer readable code means for generating one or more low-level agents arranged to monitor events occurring within the IT infrastructure;

computer readable code means for generating zero or more mid-level agents linked to one or more low-level agents for receiving data from said low-level agents and being responsive to analyze received data; and,

computer readable code means for generating one or more top-level agents linked to one or more low-level or mid-level agents for receiving data from said low-level or mid-level agents.

The computer readable medium may further comprise:

computer readable code means for generating a report; and,

computer readable code means for populating the report in dependence on data from the agents.

The present invention seeks to provide embodiments which may include one or more the following:

a method of modeling the operation of an IT infrastructure that allows different views of the infrastructure, or a property of the infrastructure, to be provided for different users;

a model of an IT infrastructure as an acyclic graph where each node comprises a property of the infrastructure, either directly observed or determined from lower level nodes and logic associated with the node; a model such as described above for which an agent is associated with each node, the agent having one or more inputs from other nodes or from an observable of the IT infrastructure and a logic for generating an output from the inputs; and

a model such as described above for which the agent provides outputs to a secure store for audit purposes.

The present invention seeks to provide a way of analyzing, evaluating and monitoring the wider IT environment and associated controls to ensure compliance with a set of policies and procedures. This involves taking raw data from the system and organizing it or analyzing it according to the policies and procedures in order to generate a high-level report showing aspects of compliance and security. Such high-level reports are not in themselves sufficient to prove or provide evidence for compliance in case of a dispute the data must also be kept with strong integrity.

In addition to monitoring the general environment, embodiments of the present invention can also be used for analyzing and evaluating how IT controls are working based on a created model. IT controls are often used by auditors for example when referring to account control and management and separation of duty processes that mitigate the risk of unauthorized access.

A system type for which embodiments of the invention are particularly suitable is a utility infrastructure providing considerable computing power and for use by a variety of different users. Utility infrastructures are intended to be flexible and adaptable, being capable of rapid reconfiguration to meet customer requirements. Rather than modelling the state an individual system embodiments of the present invention attempt to model how a dynamic set of systems is managed. This may involve checking components are in certain states but also involves checking sets of actions occur in transitioning between states. As such, the model mixes some of the system state attributes along with models of processes. An agent based framework allows for a wide variety of analysis techniques as appropriate (not just rule based systems).

Although the agent based framework should monitor processes and would gain by encompassing many of the techniques in process monitoring systems, monitoring also includes other information and events creating a picture from a number of information sources, and creating reports based on the success of multiple processes as well as other information. Preferably, adaptation of actual systems is monitored rather than the messages arriving at a workflow system—in this way events are captured that occur outside of the workflow (even when they should never be independent).

Embodiments of the present invention seek to provide a way of capturing the wider environment involved in running an IT infrastructure such as a data centre and checking that it is being run in compliance with a set of corporate policies and procedures. Such policies and procedures may even include aspects of the physical environment, such as monitoring door locks to the data centre, as well as procedures for staff vetting, patching and repair processes in addition to the usual IT management information as systems are configured or reconfigured. These aspects are described in the form of a model that relates the various procedures to high-level policy concerns as to how the system should be run. This model can then be deployed into a monitoring and analysis infrastructure to provided high level reports to senior managers showing that their IT system are compliant with corporate policies and legal regulations.

The agents may be implemented in software, hardware or some combination of the two. In one example implementation, the agents may be Java TM based agents that can be remotely deployed to a part of an infrastructure via a data communications network. In another example implementation, the agents may be hardware based and deployment includes physical installation at a part of an infrastructure.

Advantageously, a comprehensive view of a monitored system along with the management environment can be provided at various levels of detail or abstraction.

Advantageously, widening the scope of the information being captured to include all the management procedures that must be right in getting a trustable data centre is also possible. Preferably, this management information is then kept in a secure manner allowing strong evidence for compliance to be demonstrated.

Embodiments of the present invention seek to provide a graphical user interface enabling a user to design a simple reporting model linking high level goals to the audit schema. An agent framework is preferably created in dependence on the model and deployed to an infrastructure to obtain data to populate reports.

Advantageously, compliance checking is possible using embodiments of the present invention due to a comprehensive view of the system along with the management environment. Embodiments of the present invention enable visualization and querying of compliance aspects of a utility fabric. Embodiments are able to provide graphical representations of compliance in:
An “Abstract” view that shows the outline services and broad separations between different customers' resources, and also the shared resources provided by the utility and the management layer; and
A detailed view that expands on the abstract view to show a more detailed infrastructure view and highlights aspects that fail to comply.

Reach ability and dependency queries against each of these views can then be made to test the requirements against this simplified model. For example, visualization is possible to determine what barriers and shared dependencies there are between allocated resources within the utility fabric. The views can also be used to investigate the security consequences of changes in configuration, or the robustness of the current configuration to security failures or other changes.

For providing assurance to top-level customer business requirements, the abstract views provide a summary in terms of compliance and trends based on audit data and other analysis received from an infrastructure. A compliance model is produced to specify what should be monitored and tolerances for compliance and this model acts as an input to a substantially real-time analysis system that monitors and evaluates events sent by the components in the instrumented utility. The analysis system is used to generate reports for customers to provide assurance on the processes and procedures operating within the utility, i.e. how their concerns are being met. The model can also be used to explore off-line ‘what-if?’ scenarios.

The events related to the process execution are analyzed by rule engines against the expected behavior of the process. Any deviation from it is reported as an error status. Each deviation from the modeled behavior triggers another analysis process that evaluates which customer concern is mostly affected by this and by what level of severity. Finally by using the presentation logic, status errors are presented to the user as a graphical report.

Low-level infrastructure modeling can be used to help decide which procedures and mechanisms (such as VLAN switch and File Server access reconfigurations) need to be put in place within the infrastructure. These procedures and mechanisms are then monitored to produce with events that are understood by the higher level model. The higher level model produces events that are mapped onto customer requirements.

Embodiments of the present invention are also applicable for database monitoring and analysis. A database structure modeled (in a graph structure or the like) and a set of analysis objects are produced in dependence on the model. Analysis objects obtain data from the database rather than an event stream and once they have produced results from analysis, they notify other objects to which they are connected to within the graph. Results are propagated by the objects which may themselves do further processing in the manner discussed with reference to event streams.

### BRIEF DESCRIPTION OF THE DRAWINGS

Embodiments of the present invention will now be described in detail, by way of example only, with reference to the accompanying drawings in which:

FIG. 1 is a schematic diagram illustrating aspects of a utility computing infrastructure;

FIG. 2 is a schematic diagram of aspects of a system according to an embodiment of the present invention;

FIG. 3 is a diagram illustrating a model produced for use in an embodiment of the present invention;

FIGS. 4, 5 and 6 are screen shots of a report produced by an embodiment of the present invention;

FIG. 7 is a diagram illustrating components of an example policy modelled in an embodiment of the present invention;

FIG. 8 is a schematic diagram of an agent framework used in an embodiment of the present invention;

FIG. 9 is the schematic diagram of FIG. 2 in which selected aspects are shown in more detail;

FIG. 10 is a schematic diagram of an agent Java class wrapper used in an embodiment of the present invention; and,

FIG. 11 is a diagram illustrating an identity management policy modelled for use with an embodiment of the present invention.

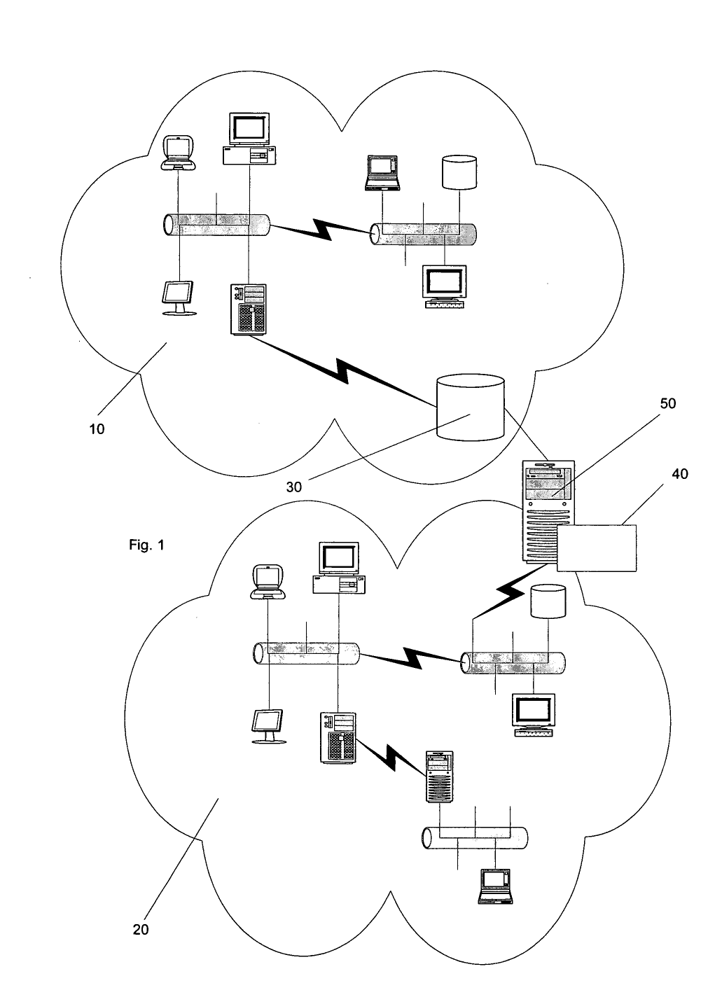

### DETAILED DESCRIPTION

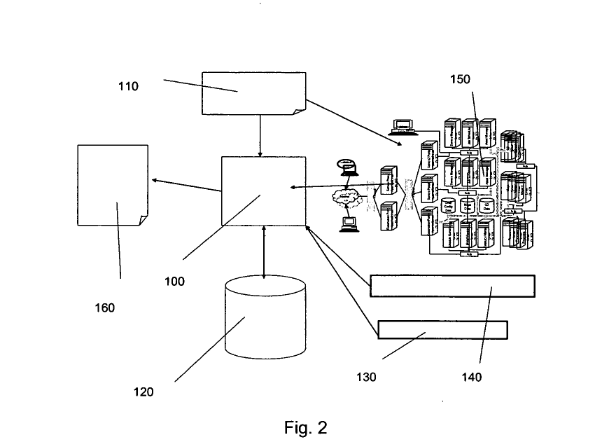

FIG. 2 is a schematic diagram of aspects of a system according to an embodiment of the present invention.

The system includes an analysis system 100 and a model component 110.

An event repository 120, an external event component 130, a management/admin component 140 and an infrastructure 150 are arranged to feed data to the analysis system 100, which, in dependence on the modelling component 110, generates a report 160.

The report 160 provides a high level summary that can be drilled down showing whether the infrastructure 150 is being run in line with corporate policies and operational procedures set out in the modelling component 110.

The modelling component 110 is used to model and implement monitoring of these policies, processes and the way they affect the underlying infrastructure. An agent framework forms part of the analysis system 100. Agents are deployed to the infrastructure 150 to monitor the infrastructure and components. The analysis system 100 interprets the event data in dependence on the modelling component 110 and uses the results to produce the report 160. The event data is stored within the event repository 120 for future reference.

A model produced by the modelling component 110, details of which will be discussed below, will vary depending on factors such as the policies to be monitored and the type of infrastructure 150. Typically, the modelling component 110 will model the infrastructure and the operational procedures. These may be defined with reference to a standard such as ITIL (the IT Infrastructure Library—a best practice standard for the provision of IT services), which could be mapped back to high level concerns such as those defined within the COBIT (control objectives for information and related technology) standard.

The model produced by the modelling component 110 may contain a number of different aspects from policies that refer to system statistics (e.g. availability or percentage of staff completing security training) through administration processes to monitoring door locks and ensuring physical access policies are maintained.

The analysis system 100 preferably supports a number of different techniques including monitoring processes, and combining the system statistics.

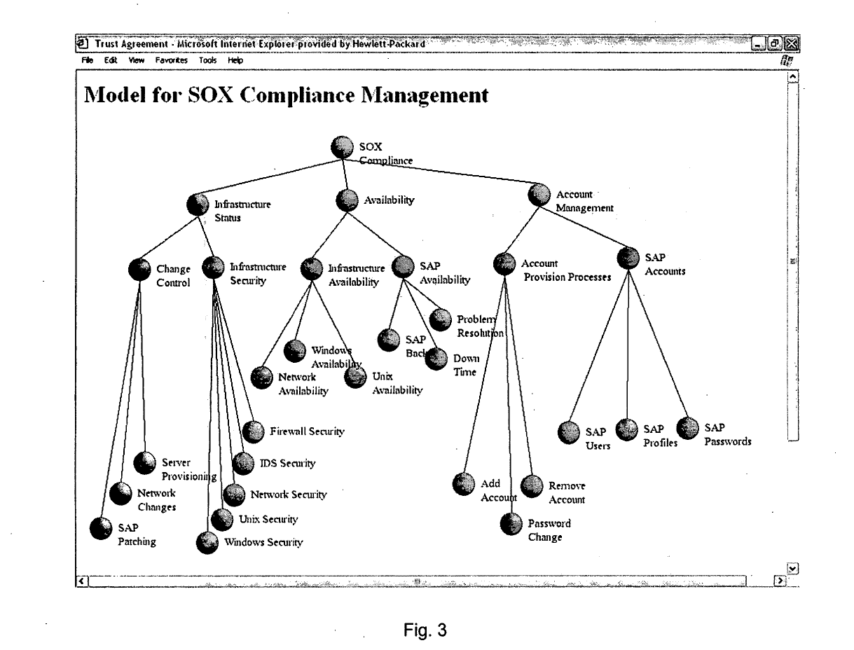

FIG. 3 is a schematic diagram illustrating policy and process aspects that may be modeled by the modeling component according to an embodiment of the present invention.

In the case of Sarbanes Oxley (SOX) compliance monitoring, both the integrity of financial processes and the supporting IT infrastructure are critical factors. With respect to the IT infrastructure, events associated with various management processes will impinge on this and will need to be monitored along with a set of significant system statistics.

In setting up the monitoring system discussed with reference to FIG. 2, a company's concerns and policies or processes are identified to ensure they are monitored. SOX compliance will undoubtedly be one of these high level concerns. Typically, there are three key aspects relating to how the company's finance system is run: the infrastructure integrity; availability; and account management. These in turn are further refined to define the infrastructure integrity as being dependant on the security of various components and also dependent on change management and patching processes being well run. Account management again is made dependent on the processes used for adding, changing and removing accounts. Account management may also be linked to various statistics that are indicative of well-run accounts as well as tracking each process instance. Monitoring the account adding process involves monitoring both the workflow that should be followed and the way it affects certain system components (e.g. a SAP user database). Monitoring these dependencies ensures the analysis covers various levels of system architecture from management through to system and network views. FIG. 3 is a tree diagram illustrating the aspects to be monitored and their dependencies.

Agents are generated in dependence on the aspects modelled in the modelling component and deployed to necessary parts of the infrastructure. Details of the agent framework, agents and their deployment is discussed in greater detail below.

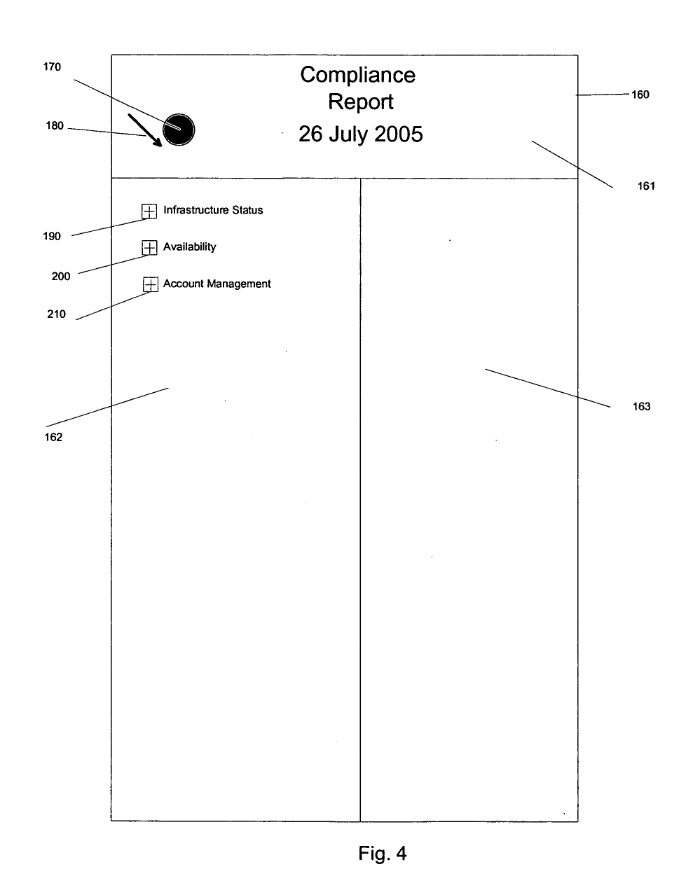

The analysis system 100 receives data from the agents, processes the data based on dependencies set within the modelling component 110 and populates the report 160. An example of a top level of a report 160 is illustrated in FIG. 4.

The report 160 includes a summary section 161, an index section 162 and a detail section 163.

The summary section 161 includes a status indicator 170 in the form of a coloured traffic light and a trend indicator 180 in the form of an arrow. The two indicators provide at-a-glance status information for executives and the like indicating overall compliance based on the model set in the modelling component 110 via the status indicator 170 and also an indication of any change in compliance via the trend indicator 180.

The status indicator 170 may have any number of reporting levels, although preferably it is based on traffic lights, displaying green when the analysis system 100 deems the infrastructure 150 compliant (within any preset tolerances), amber for minor compliance problems and red for major compliance issues. The trend indicator 180 is preferably in the form of an arrow pointing upwards to indicate a positive trend change, downwards to indicate a negative trend change or horizontally for no change. Depending on the complexity of the model and system implemented, the incline of the arrow may be dependent on the respective trend change. Tolerances, the amount of time over which trends are monitored and minor and major compliance issues can be preset when preparing the model in the modelling component.

Preferably, the report 160 is web based and allows the user to drill down via the index section 162 to explore specific aspects of the model. The index section illustrated in FIG. 4 includes entries for the top level aspects 190, 200, 210 defined in FIG. 3 and allows a user to select one or more to drill down into detail in each of their respective dependent aspects.

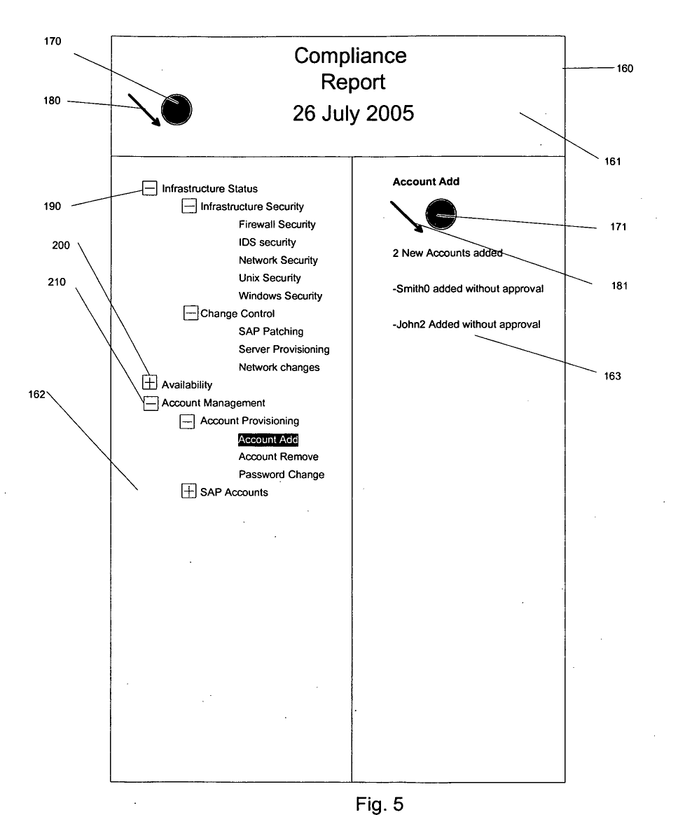

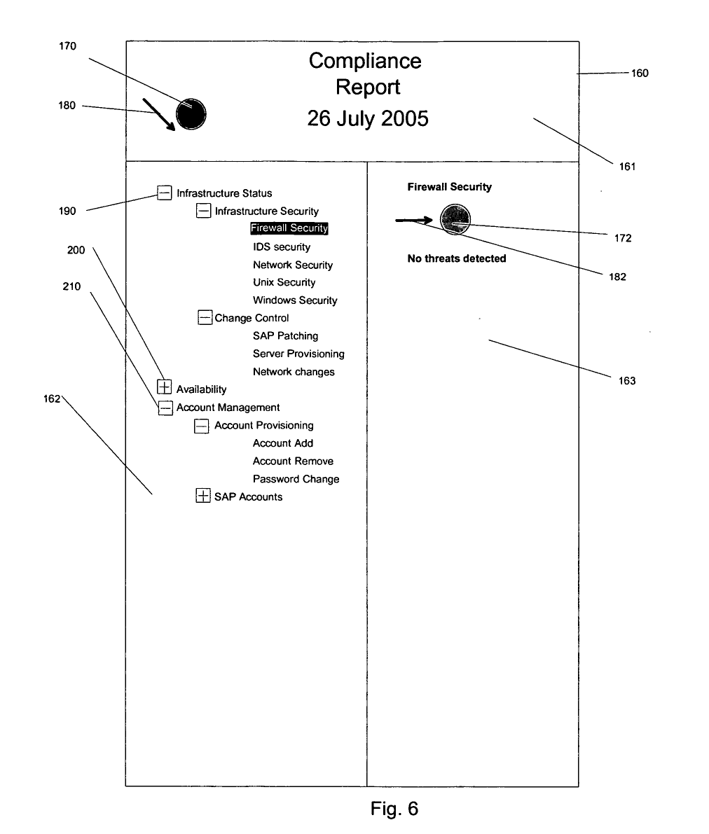

FIGS. 5 and 6 illustrate example aspects drilled down to provide more detail to the user.

In FIG. 5, the “Account Add” section has been selected and the detail section 163 is populated with a status indicator 171, trend indicator 181 and detailed information on this section. It can be seen that 2 new accounts were added without approval, contravening a policy and therefore setting the status indicator 171 red (non-compliant) and the trend indicator to point downwards. Depending on the model implemented and any weights associated with particular model and policy aspects, this policy contravention may have been enough to set the overall status indicator 170 in the summary section 161 to red.

In FIG. 6, the “Firewall Security” section has been selected and the detail section 163 is populated with a status indicator 172, trend indicator 182 and detailed information on this section. It can be seen that no threats had been detected meaning that the status indicator 172 is set to green (compliant) and the trend indicator 182 is set to horizontal (presumably reflecting that this section has had such a status for some time meaning that no change in trend has been detected).

In utility computing scenarios, model based reporting and monitoring such as that used in embodiments of the present invention can be used, for example to model of how a data centre should be run to help interpret data about events happening to the system and its environment. The model allows the concerns of the customer to be captured. For example, in a film rendering service this may include concerns about the confidentiality of the film data. Confidentiality is dependent on a number of factors including the system configuration but probably more importantly that the data centre is being run correctly. Models may include aspects of physical security, staffing by ‘fit and proper’ people, patch and incident management procedures. It is often these environmental aspects that are at the heart of security and therefore critical to maintaining a trustable system.

The modeling component 110 allows these various aspects to be represented with the analysis system 100 correlating raw events against raw events to derive a high level report 160 reflecting the mix of priorities that can be provided to and easily used by the customer. This provides the necessary degree of transparency for the user. It is, however, also desirable to maintain a measure of accountability so that the provider must stand by the view given in the report and cannot subsequently change the data—this is achieved by archiving the data received at the analysis system 100 in the repository 120. Tamper proofing such as use of an evolving chain based cryptographic hash could be sued to secure the data within the repository 120.

A graphical user interface is preferably provided to allow users to define the model implemented by the modeling component 110 and analysis system 100.

The model defines how to analyze, interpret and report raw audit data. To get a report that reflects the concerns of an organization, the model structure can be extended and customized to define analysis rules to be applied and how the rules link to the underlying audit data.

The graphical user interface could be in the form of a graph drawing system allowing various types of analysis nodes to be created, interconnected and linked into the raw data sources to define dependencies.

Details, such as thresholds or processes could be customized within the user interface. As such each analysis type could be modifiable to change configuration data, such as thresholds for statistical analysis or sequence patterns for process behavior description.

A model to be used by the modeling component 110 takes the form of a tree-like structure with the first level of branches representing a set of goals or policies for the infrastructure. For example these could be keeping information with integrity, ensuring the integrity of the applications, or the confidentiality of the data. Such top level concerns expressed at the top of the tree lead down to subsidiary concerns (referred to as mid level) and at some point to low level processes or elements that can be checked directly as individual events or checks that can be run on a machine or based on received audit data etc. For a process, the model generally describes the sequence of events that should happen, defines when processes fail and indicates the significance of events received outside of a process.

The subsidiary concerns are typically sub-policies involved in ensuring that the higher-level goals can be met. These refinements are associated with importance measures allowing the criticality of failing to meet them to be reported. Sub-policies are added to the tree structure as child branches indicating their dependency to the higher level policies.

At some point in the refinement the tree will produce dependencies on the running of management procedures, workflows, handling of incidents, statements regarding the system state and the significance or unattributable events. These procedures and processes are further decomposed. For example, a patch management process may be described in terms of a number of sub-processes (assessing vulnerabilities, validating patches, applying to critical/non-critical machines). Different types of information of interest in the running of such procedures is also defined. For example, success, failure with roll-back to a secure state, failure, reaching a given point, running slowly. All these pieces of information can be used in defining the high level goals.

Each process description contains information about the systems to which it applies and agents (either information agents, or other analysis agents) that indicate something has happened. These agents form the leaves of the agent framework tree structure and represent the basic information that can be derived from various pieces of the IT infrastructure or its environment. In the model these describe information sources (for example about events with in a work flow, or events that happen on reconfiguring an OS).

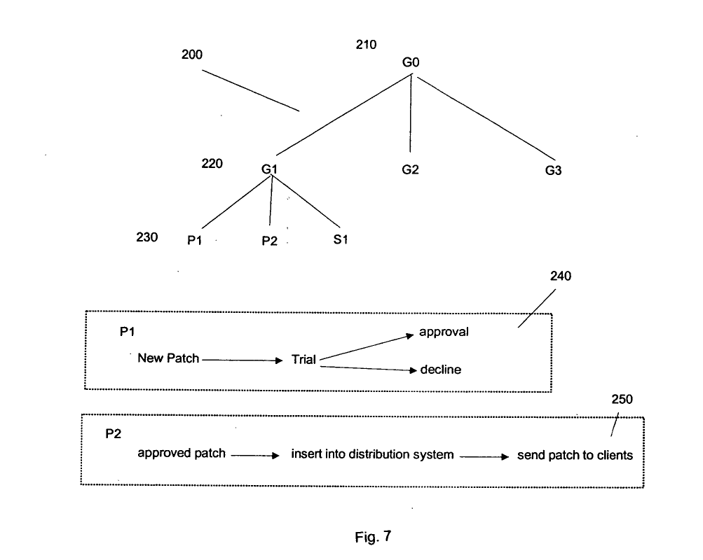

An example of part of an agent framework is illustrated in FIG. 7. A top level goal G0—compliance—is set as the highest node 210 in the tree 200. Subsidiary (although still high-level) goals 220 (G1-G3) are set at the next (mid) level. For example, G1 may be patch management. The processes and statistics used to determine whether the goal G1 is met are shown at the next level 230 in the tree 200, however it will be appreciated that this is simply due to the compliance policy illustrated and many more levels of abstract goals could follow before processes, mechanisms and statistics to be analyzed to determine if those goals are met are encountered. Similarly, not all processes, mechanisms and statistics will appear at the same level—this will depend on the complexity of each sub-policy modeled.

Goal G1 is dependent on processes P1 and P2 and statistic S1. In this example, process P1 concerns patch assessment while process P2 concerns patch deployment. Details of the actual processes modeled and their respective possible outputs are shown in areas 240 and 250 of FIG. 7. Statistic S1 concerns percentage of approved patches applied.

The condition for goal G1 is defined as:
P1 AND P2 and (SI>98%)

Goal G1 is therefore satisfied if processes P1 and P2 report success and over 98% of approved patches have been applied.

It will be appreciated that much more complex processes, statistics and goal conditions could be modeled.

Although the above models have been described above as tree-like structure, an acyclic graph is a more accurate description. Processes and information will often be relevant in ensuring that a number of goals are met (although the degree of importance may vary). For example, the success of a patch management process or failures in updating firewall rules both have implications in the integrity of applications and the confidentiality of the data. Given that many IT processes and systems will be common over instances of a utility or service, standard model modules can be developed that can be included into this framework.

Models may themselves be dynamic, with the model describing how it changes itself when a process runs—the systems may adapt and the model enlarge or shrink in a particular way.

In summary, the model structure an agent framework can be considered as an acyclic graph with a single high level node at the top, a number of leaf nodes at the bottom, and (generally) a number of intermediate nodes. Each node has associated with it one or more inputs (which may be direct observations of the system for leaf nodes or may be outputs of other nodes for intermediate nodes or the top node), one or more outputs (consisting of an indication of the status of the top level concern for the top node) and some associated logic. The logic associated with a leaf node may be trivial (it may consist simply of the node being allowed to take on one value from alternatives, or in a range) whereas logic associated with intermediate nodes may be substantially more complex.

In the case of a utility computing infrastructure, a model is derived that reflects the risks of a customer. Lower level processes for running a utility will be captured and modeled by the utility with the customer being given some view into this data. Other aspects may vary for each customer depending on their risk profile.

Such views can be introduced as elements of a customer's own model so as to integrate it with the customer's own systems and processes.

Once the model has been defined in the modeling component 110, an agent framework is implemented by associating agents with the model's nodes.

Agents are deployed into an infrastructure 150 to capture information required by the model. In appropriate embodiments, certain of these agents will capture things happening in the IT systems and others will capture events relating to the management workflows, whereas others may monitor the door locks to the data center, others monitor HR systems as staff come and go, and others even monitor external systems (perhaps reporting newly-discovered vulnerabilities and new patches).

The process of associating agents with nodes may be carried out using a distributed configuration and management system such as SmartFrog (www.smartfrog.org). SmartFrog allows a model of the desired state of a distributed system to be created and then deployed by a set of agents. The state of the agents can then be queried. The SmartFrog framework can therefore be used to describe and deploy a distributed set of information and analysis agents. Thus, given a model defining how a system should be run, a set of agents and deployment information may be generated.

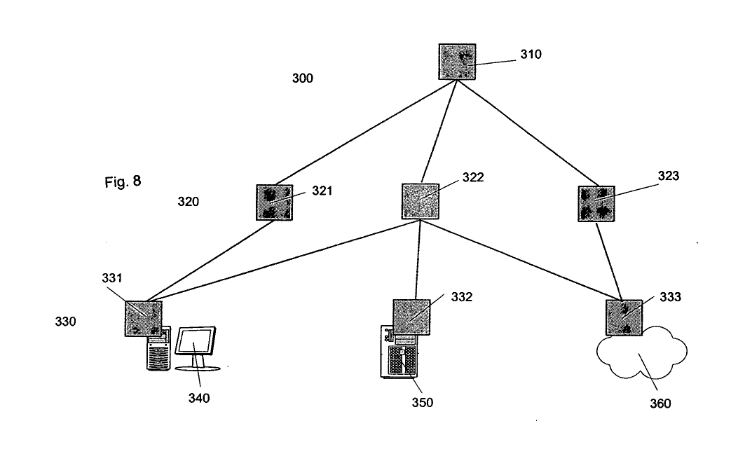

To avoid congestion at the analysis system, it is preferred that models are deployed using a tree-like hierarchy in a similar manner to the way models are defined. FIG. 8 is a schematic diagram illustrating the relationship between agents in an example implementation.

Low level agents are typically associated with nodes of the model and are tasked with monitoring the predetermined part or aspect of the infrastructure 150 to derive the required information from the IT infrastructure. Higher level agents may be tasked with some analysis and combining of received event data from lower level agents. Agents are able to register with other agents so that they will be notified of relevant events. As agents find significant data (with “significant” defined according to the model) they send notification of events to agents that have registered an interest. All the event information is also sent to the repository 120.

At the low level (appropriate to leaf nodes), analysis agents are deployed to look for, (or generate on demand) events that represent the state or changes in the state of the infrastructure or its components. These will range from a management action (e.g. initiating a workflow to provision a new server) through to agents monitoring changes to access control lists, firewall rules or switch configurations.

A mid-level agent receives events from agents to which it has registered an interest and uses its logic on the collection of events to provide an appropriate output—specifically, this analysis process will lead to it generating events when certain conditions are reached (as defined in the model). The analysis that is performed will depend on the model—in examples, it may involve tracking a workflow, or validating the state of a set of systems, or even dealing with events that occur outside of a workflow.

Agents are deployed following the model. However, if the IT infrastructure is dynamic the agent infrastructure must also be dynamic. For example, a process responsible for deploying a new server will include setting up information agents on that server. The analysis agents can register to receive events associated with this provisioning and adapt the analysis to deal with this new information.

Top level agents will write data into a report structure enabling a manager to view how the system is being managed against the model. A manager may be allowed to dig down in more detail by looking at the events that have been sent to the database.

An analysis agent receives events from agents to which they have registered an interest and may perform some form of logic on the collection of events. This analysis will lead to it generating events when certain conditions are reached (as defined in the model). The analysis that is performed will depend on the model but may involve tracking a workflow, or validating the state of a set of systems or deal with events that occur outside of a workflow.

Events, and possibly analysis results, are stored within the repository 120, which may be a database system or other storage system. High level analysis results get passed into a trust record portal which uses them to form a high level report view for a customer. The customer can also dig down further into the data used to generate the high level reports. This is done using the model structure to navigate through the event structure. This arrangement allows the possibility that that the data used in generating reports can be explored further. For example, in the case of a dispute, it is not enough to have a high-level report stating the system was compliant but the report must be justifiable.

Hence the repository 120 records the raw data along with various partial analyses allowing users to be able to walk through the data seeing how it was generated and validating its integrity.

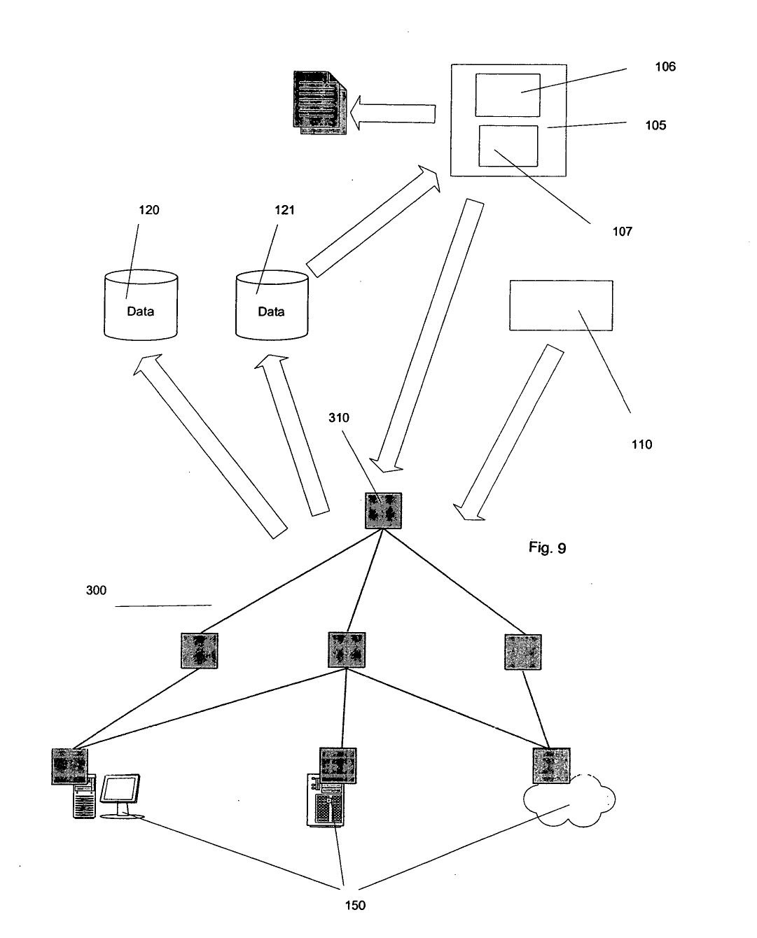

FIG. 9 is a schematic diagram of the system of FIG. 2 illustrating selected aspects in greater detail.

From the foregoing, it will be appreciated that in a preferred embodiment, the analysis system 100 is formed by the agent framework 300.

A request to generate a new report triggers a call to a top level agent 310, which in turn propagates the call down through linked agents (as configured via the modeling component). Once analysis data is available at a particular agent, it will activate a call-back function to send the data to other agents registered to receive that data.

A specific agent may have its own configuration information customizable via modeling component that is picked up as the request to generate a report is propagated. Once an agent has been notified that all the required data is available, a predetermined analysis routine is performed on the data. Depending on the form of the data this may be a results set from an SQL query where bulk data is expected (e.g. at the leaves of the graph) or a value passed within the call-back as results trickle up the agent hierarchy to the top level agent 310. Analysis routines may include process analysis techniques to find events that indicate system changes outside of a process; and checks against security matrices (for example checks or reports showing where a separation of duty matrix may have been violated—for example detection of a user being given two roles that should not exist together or use of two roles by a user in a transaction).

Each agent is arranged to write results into a report database 121 that will be used in report generation once analysis is complete. Each agent may also have its own data store where it can store state for performing tasks such as trend analysis.

There is some flexibility as to how the instantiation of the analysis agent framework from the modeling component 110 should occur. The result should be a set of interlinked agents, each of which are configured with the required data sources.

There are at least two options how agents are instantiated:

configuration files could be produced and read during instantiation that list both the data sources and references along with analysis specific data; or,

generation of java classes containing the configuration from preconfigured analysis templates.

In producing the report, there are likely to be a number of agent types required.

An analysis class would need elements including the actual analysis code, configuration code that takes into account configurations from the modeling component 110 and (possibly) report generation code that allows customization of the report for a particular analysis result.

A number of analysis techniques are likely to be needed, even in a basic implementation. These may follow the currently explored techniques for sequence tracking and combining statistics using a variety or techniques (weighted sums or fuzzy combinations). A number of other types of analysis could be incorporated for example using outlier detection or robust regression techniques to detect if statistics are within the normal behavior. Classification and clustering techniques would also be useful in analyzing behavior patterns. Similarly, intelligent and/or evolving technologies could be used within agents such as neural networks, genetic programming and the like. Such intelligent or evolving agents could be given a roving brief and not specifically assigned to a particular part or entity of the infrastructure or process but instead allowed to select what is monitored/analyzed to detect issues that standard agents would not otherwise identify.

A report generator 105 manages the reporting cycle and forms the report.

Management of the reporting cycle includes triggering of reports on a predetermined periodic basis, and once created distribution of the reports to various interested parties. In one embodiment, the report generator 105 includes a reporting daemon 106 that periodically triggers a new report. A workflow system 107 could be used to deal with distribution and ensuring that reports are viewed.

Preferably, the report generator will be servlet based. Report preferably follow the structure of the model defined in the modeling component 110.

It may be desirable to allow different users of the system (these may include different customers, but may include administrators and other parties with different relationships to the IT system) different views of the same report. These may be different views relating to a single top level concern. This could be because different users have different models for the top level concern (having different processes and concerns) or because they have visibility of different information. An approach that allows such different views to be generated is discussed briefly below.

Even where different views are possible, elements (nodes and substructures) are likely to be common and it is thus desirable for a utility computing provider to provide a number of model components describing processes and infrastructure they manage that customers can see. Customers can then build a high-level model defining the policies that they with these components to achieve. These model components can be created in a way that ensures they can be specialized for each customer, report information for all customers, or only the results showing a process has run may be available to a customer. Each of these can be deployed within the agent framework using common agents where required.

Confidentiality concerns may be addressed by introducing a set of index tags into the event and agent infrastructure. Each agent has a tag set and a function that takes an event it has generated and generates a tag for the event in accordance with the agent's tag set. An agent is allowed to receive events tagged with any value within its tag set (in some cases, this may of cause be any tag). An agent may also generate events for any value within its tag set based on a tagging function which takes account of the event structure. For example, an event may have a customer “x” field which would determine that the event is tagged with a “customer_x” tag. The tags are used for two purposes: as confidentiality markers, they are used to provide access control on the however, they may also be used to control the event flow though the system.

In some cases, a tag may not be pre-assigned but will be needed to be assigned dynamically—this may apply, for example if standard nodes are prepared for customers and only allocated to a particular customer when required. Such dynamic tags may be based on a transaction id and a type. Agents may be allowed to receive dynamic tags and they may after the resulting analysis be able to generate new related events tagged for a particular customer. Such an agent is also responsible for entering the dynamic tag in the set of tags viewable by that customer.

The root agent of an analysis framework for a customer should have a single tag that corresponds to that customer. In a customer analysis, as the customer digs through the event history within they may need to see multiple tags—if so there will need to be provided a database defining the tags a customer can see. In an example, a customer may then see its own data along with public data from the utility (say digging to a certain level into management processes such as staff vetting, patching) but not deeper detail may be kept private to the utility. The set of tags enable access control decisions to be made—it may also be used to organize data for encryption or for secure indexes.

Alternatively, each customer could work with the utility computing provider to generate a model of the various utility processes and infrastructure components in which they are interested. Each of these models will differ from a generic single model in that there is a way of determining that the information belongs to a particular customer.

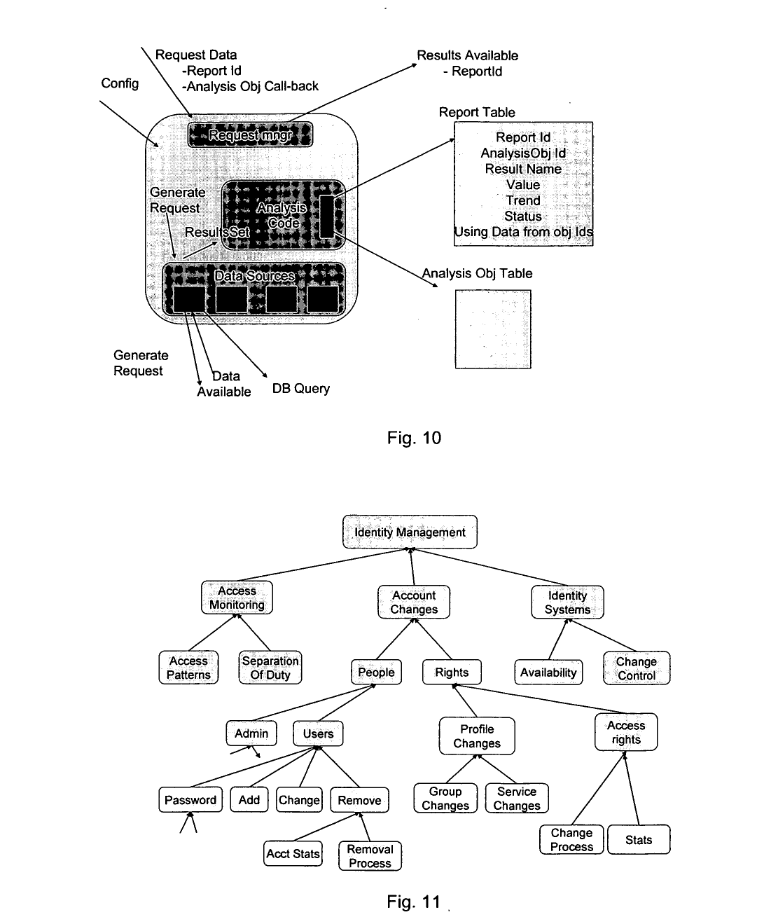

Agents are preferably java objects each inheriting from a general analysis class wrapper such as that illustrated in FIG. 10. Configuration data defines the inter-relationship between agents and is applied when the agents are created in dependence on the model from the modeling component 110.

FIG. 11 is a schematic diagram illustrating a model produced for identity management.

In identity management, three main aspects need to be taken into account: account provisioning, unauthorized access tracking and change control. These three aspects cover the whole lifecycle of account management, from user provisioning to access patterns and changes of account permissions or administration processes.

In building the model structure, the types of audit data available is taken into account.

Access Monitoring—The high level goal here is to report that there is some monitoring of access patterns and that they do not break particular policies, unusual access patterns are rare or that they have been investigated. Such analysis could be based on the analysis of access logs from Select Access to look for unusual patterns or log those accessing certain resources. Other analysis could be aimed at checking separation of duty is managed by looking at admin actions on identity and access right provision.

Identity Systems—In order to have confidence that processes required to manage identity are well run an auditor needs to know that the supporting systems are well run. In itself this falls into two camps, ensuring that the throughput of identity transactions is sufficient and that there is strong change control on the systems.

The throughput (or lack of it) of the identity transactions could be indicated by a number of audit messages such as connectivity failures. This can be based on the number of unsuccessful identity provisioning processes or the amount of authorization workflow escalations happening (not clear if these are logged). Transaction numbers (e.g. allow/deny) could be counted but without system load information it would be hard to compare them against required throughput expressed in the model.

For change control we need to consider why changes to the main system components are happening and how often. Without linking to an IT helpdesk/change control process management system it is probably hard to check that the identity systems change control processes are correctly run. Audit events such as SA start up, shutdown, configuration changes and Si resource connector additions would indicate that systems are changing so we can gather statistics about these changes. It will be harder to determine why the changes are made and hence what is acceptable amount within specified period.

Account Changes—A major theme in ensuring compliance is correct account management. Here there are two major concerns: how users are managed and how their permissions/rights are changed.
People Management—That is, are user accounts well managed? Here we assume that there would be some form of customizable template that can be applied to different classes of users. For example, administrators and other users—we assume we could derive this information rather than having to deduce it from the audit logs.
For each class of user we have identified four basic areas of adding, changing, and removing users along with password management. The latter of these we assume would be based on some analysis of the password change, reset, reset by hint and hint setting reports.
The processes of adding, changing and removing users would be mainly derived from the account audit report and user audit report data generated. Ideally, we would check (maybe sample) that the processes are running properly. Reconciliation functionality could be used in comparing perceived rights with the actual user databases.
Rights Management—Good rights or privilege management suggests that there are strong processes to determine and authorize those who can access particular resources. As such rights management analysis should look at audit records and group allocation along with the processes involved in allocating rights.
The rights management could be split into managing administration rights (e.g. looking at changes to delegated administrators, or administrator account activities) and changes to service rights (e.g. looking at the user configuration reports, group and service audit reports and audit messages from logging changes to groups, Users or resource tree entries, authentication servers, and access rule).
Additional statistics such as the number of changes can be derived as these may indicate that processes are being initiated. Such statistics could count the number of changes of a particular type.

Although various technologies have been discussed in the above embodiments, it will be appreciated that other technologies, particularly in implementing the agents, could be used. In particular, agents need not be software entities and could be hardware, programmed firmware or some combination of the two. Deployment of the agents could be done manually by installation or by use of intelligent mobile agents.

1. A monitoring system for monitoring compliance of a policy in an IT infrastructure comprising a modeling component and an analysis system:
the modeling component being arranged to model the policy and configure the analysis system in dependence on the model;
the analysis system being arranged to monitor aspects of the IT infrastructure in dependence on the model.

2. A monitoring system according to claim 1, wherein the analysis system includes an agent framework arranged to be deployed to the IT infrastructure for monitoring aspects of the IT infrastructure in dependence on the model, the agent framework including a number of linked agents.

3. A monitoring system according to claim 2, wherein the agent framework includes:
one or more low-level agents arranged to monitor events occurring within the IT infrastructure;
zero or more mid-level agents linked to one or more low-level agents for receiving data from said low-level agents and being responsive to analyze received data; and,
one or more top-level agents linked to one or more low-level or mid-level agents for receiving data from said low-level or mid-level agents.

4. A monitoring system according to claim 3, wherein each agent has one or more inputs and includes logic for generating at least one output in dependence on the one or more inputs, each input being from another agent or from an observable of the IT infrastructure.

5. A monitoring system according to claim 3, wherein the analysis system is arranged to generate a report and populate the report in dependence on data from the agents.

6. A monitoring system according to claim 5, wherein the report has a hierarchical structure, placement within the report of data from an agent being dependent on the corresponding position of the respective agent within the agent framework.

7. A monitoring system according to claim 5, wherein the analysis system is arranged to generate different views of the report for different user types.

8. A monitoring system according to claim 2, wherein the IT infrastructure includes a database system, one or more of the linked agents being arranged to monitor events or activity occurring within the database system.

9. A method of monitoring compliance of a policy in an IT infrastructure comprising:
modeling the policy;
configuring an analysis system in dependence on the model, and,
monitoring aspects of the IT infrastructure by the analysis system in dependence on the model.

10. A method according to claim 9, wherein the step of configuring the analysis system includes:
generating an agent framework for monitoring aspects of the IT infrastructure in dependence on the model, the agent framework including a number of linked agents; and,
deploying the agent framework to the IT infrastructure.

11. A method according to claim 10, wherein the step of generating an agent framework includes:
generating one or more low-level agents arranged to monitor events occurring within the IT infrastructure;
generating zero or more mid-level agents linked to one or more low-level agents for receiving data from said low-level agents and being responsive to analyze received data; and,
generating one or more top-level agents linked to one or more low-level or mid-level agents for receiving data from said low-level or mid-level agents.

12. A method according to claim 11, wherein each agent has one or more inputs and includes logic for generating at least one output in dependence on the one or more inputs, each input being from another agent or from an observable of the IT infrastructure.

13. A method according to claim 11, further comprising:
generating a report; and,
populating the report in dependence on data from the agents.

14. A method according to claim 13, wherein the report has a hierarchical structure and placement within the report of data from an agent is dependent on the corresponding position of the respective agent within the agent framework.

15. A method according to claim 13, further comprising:
generating different views of the report for different user types.

16. A method according to claim 10, wherein the IT infrastructure includes a database system, one or more of the linked agents being arranged to monitor events or activity occurring within the database system.

17. A computer readable medium having computer readable code means embodied therein for monitoring compliance of a policy in an IT infrastructure and comprising:
computer readable code means for modeling the policy;
computer readable code means for configuring an analysis system in dependence on the model, and,
computer readable code means for monitoring aspects of the IT infrastructure by the analysis system in dependence on the model.

18. A computer readable medium according to claim 17, wherein the computer readable code means for configuring the analysis system includes:
compute readable code means for generating an agent framework for monitoring aspects of the IT infrastructure in dependence on the model, the agent framework including a number of linked agents; and,
computer readable code means for deploying the agent framework to the IT infrastructure.

19. A computer readable medium according to claim 18, wherein the computer readable code means for generating an agent framework includes:
computer readable code means for generating one or more low-level agents arranged to monitor events occurring within the IT infrastructure;
computer readable code means for generating zero or more mid-level agents linked to one or more low-level agents for receiving data from said low-level agents and being responsive to analyze received data; and,
computer readable code means for generating one or more top-level agents linked to one or more low-level or mid-level agents for receiving data from said low-level or mid-level agents.

20. A computer readable medium according to claim 17, further comprising:
computer readable code means for generating a report; and,
computer readable code means for populating the report in dependence on data from the agents.
